(19) United States
(12) Patent Application Publication
(10) Pub. No.: US 2024/0408832 A1
(43) Pub. Date: Dec. 12, 2024

(54) ANGULAR ANNEALING PROCESS

(71) Applicant: The Supreme Industries Limited, Mumbai (IN)

(72) Inventor: Ole-Bendt RASMUSSEN, Walchwil (CH)

(21) Appl. No.: 18/273,986

(22) PCT Filed: Jan. 25, 2021
(86) PCT No.: PCT/IB2021/050533

§ 371 Date: Jul. 25, 2023

(51) Int. Cl. B29C 71/02; B29K 23/00

(52) U.S. Cl. CPC B29C 71/02; B29C 2071/022; B29C 2793/009; B29K 2023/065; B29K 2023/12; B29K 2995/006; B29K 2995/0096

(57) ABSTRACT

A procedure wherein a tubular high molecular weight polymer film which has been longitudinally stretched and therefore is longitudinally shrinkable, is converted by helical cutting to second polymer film, which then is heated and relaxed in order to partly or totally eliminate the shrinkability, whereby one edge of the helically cut film, inevitably becomes longer than the other edge, referring to a relaxed stated, characterised in that second film is converted to third film by continuously advancing second film in a first direction towards a lineary zone which extends perpendicularly to the edges of the cut film, while heating the film to a temperature lower than but close to its melting range, and in direct succession hereto moving the heated film at velocity (v) in a second direction which forms a small angle (a) to the first direction, the velocity (v) and angle (a) being selected to reduce or totally eliminate the difference between the lengths of the edges.

Improved method of providing a high molecular weight polymer film with a stabilized angular molecular orientation.

The objective of the invention appears from the title. The expression “angular molecular orientation” should for practical purposes be understood as a molecular orientation in an angle higher than 15° and lower than 75° seen in relation to the machine direction. Such films are mainly used for manufacture of “cross-laminates”, for example a film oriented under +45° laminated with a film oriented under −45°. “Cross-laminates” based on synthetic crystalline polymers, and a helical-cutting method carried out on tubular, longitudinally, oriented film to establish the angular orientation, was first patented by the present inventor about 60 years ago. Special “cross-lamination” processes have later been proposed in other patents.

However, the inventor has observed that there still is an outstanding problem in connection with helical cutting of longitudinally oriented, tubular polymer film. When such a film is laid flat and tensionless on the floor, one edge becomes slightly longer than the other edge, the shape of the film being slightly circular. I say the film has “banana-shape”. The reason is that it tends to shrink on bias, since its molecular orientation is biased. When two such films are “cross-laminated” in a continuous process, the tendencies to “banana-shape” in the two films counteract each other and lose importance, except at the corners of the laminate. These corners show a strong tendency to bend diagonally, to curl. This is clearly a disadvantage, especially when the “cross-laminate” is used as a cover-film without any means to fix the corners. The main purpose of the invention is to reduce or totally eliminate this curling. Another purpose is to avoid wrinkling due to the “banana-shape”.

Thus, the process of the invention starts with longitudinal stretching of a tubular (normally lay-flat) high molecular weight polymer film. This may have been stretched at a temperature close to the melting range and in a stretching ratio close to the point of rupture. In that case, the stretching is a straightforward process. It may also be carried out at a lower temperature and/or at an essentially lower stretch ratio. In that the case the stretching procedure claimed and described in my co-pending British patent application, GB1917643.7, can be used. This longitudinally stretched tubular film is longitudinally shrinkable. As a next step of the process it is converted by helical cutting to an angularly oriented film, referred to as “second film”. This is heated in order to partly or totally eliminate the shrinkability. As mentioned above, one edge of second film thereby becomes slightly longer than the other edge, referring to the relaxed state. To solve this problem, the second film is converted to third film by continuously advancing it in a first direction towards a lineary zone which extends perpendicularly to the edges of the cut film, and in direct succession hereto moving the heated film at velocity (v) in a second direction, which forms a small angle (a) to the first direction. The velocity (v) and the angle (a) are selected to reduce or better totally eliminate the difference between the lengths of the two edges. This selection is best established by trial and error. The movement in second direction is carried out by means of driven rollers.

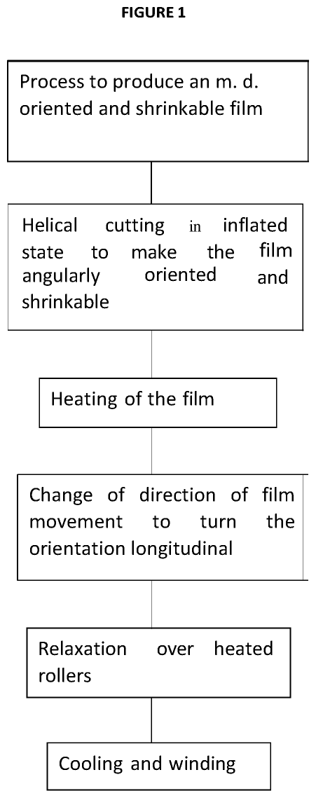

There is preferably added a stabilization step, which may be in line with the last mentioned step, or may be carried out separately. It is preferably done under relaxation of the frozen tension in the film. The process is illustrated in the attached flow-sheet (FIG. 1).

For most applications, it is preferable that the film consists of a polyolefin, for example PP or HOPE, or consists of a biodegradable polymer.

I also claim protection for any set of apparatus, which is suitable for carrying out the described process, and any product obtained by this process, including products which further have been laminated. For some purposes this should be a “cross-lamination” process, especially “cross-lamination” of two films, which both were produced by use of the claimed process.

1. A procedure wherein a tubular high molecular weight polymer film which has been longitudinally stretched and therefore is longitudinally shrinkable, is converted by helical cutting to second polymer film, which then is heated and relaxed in order to partly or totally eliminate the shrinkability, whereby one edge of the helically cut film, inevitably becomes longer than the other edge, referring to a relaxed stated, characterised in that second film is converted to third film by continuously advancing second film in a first direction towards a lineary zone which extends perpendicularly to the edges of the cut film, while heating the film to a temperature lower than but close to its melting range, and in direct succession hereto moving the heated film at velocity (v) in a second direction which forms a small angle (a) to the first direction, the velocity (v) and angle (a) being selected to reduce or totally eliminate the difference between the lengths of the edges.

2. A procedure according to claim 1, characterised by adding a separate or inline heat-stabilisation step, preferably under relaxation.

3. A procedure according to claim 1, characterised in that the film mainly consists of a polyolefin such as HOPE or PP or of a biodegradable polymer.

4. Any apparatus suitable for carrying out the procedure according to claim 1.

5. Any product obtained by the procedure according to claim 1, including a product which further has been laminated, e.g. has been cross-laminated with a similarly manufactured film.
